(19) United States
(12) Patent Application Publication
(10) Pub. No.: US 2009/0055265 A1
(43) Pub. Date: Feb. 26, 2009

(54) Lost key rewards system and method

(76) Inventor: Maria Lavoice, (US)

Correspondence Address: CAROL N. GREEN, ESQ.;LAW OFFICE OF CAROL N. GREEN, P.A., WACHOVIA FINANCIAL CENTER, 200 S. BISCAYNE BLVD., SUITE 2750, MIAMI, FL, 33131, US

(21) Appl. No.: 12/074,942

(22) Filed: Mar. 8, 2008

Related U.S. Application Data
(63) Continuation-in-part of application No. 11/894,347, filed on Aug. 21, 2007.

(51) Int. Cl. G06Q 99/00

(52) U.S. Cl. 705/14; 705/1

(57) ABSTRACT

A lost key rewards system and method which allows key owners to register their traditional keys as well as “advanced”, programmable key information with a central database accessible by a world wide website portal where the key owner's contact information is kept private and confidential. In particular, the lost key rewards system and method utilize an encoded key tag, each with a unique key tag number that a key tag owner may attach to their keychain or key ring. The key tag also has instructions for accessing a specified website and forwarding the found key tags for a reward. A key tag finder may participate in the program by registering the found keys and its specific key tag with its unique key tag number along with their contact information. Thus, if the key tag owner's keys and key tag are lost and found, the key tag finder has a system and method of returning the keys and/or key tag to the key tag owner and may choose to receive a reward. This lost key rewards system and method also provides the opportunity for large or small corporations to incorporate the key retrieval system as an employee and/or customer reward program and additional advertisement for the company through their logo being placed on a key tag.

### PRIORITY CLAIM

The present application is a Continuation in Part of U.S. Non-Provisional patent application Ser. No. 11/894,347 titled Lost Key Rewards System and Method, filed Aug. 21, 2007. The entire disclosure of the Non-Provisional application Ser. No. 11/894,347 is incorporated herein by reference.

### FIELD OF THE INVENTION

The present invention is directed to a computer implemented lost key rewards system and method which comprises of a central electronic database providing for the confidential registration of a key owner's contact and key information to facilitate the return of a lost key, while providing for a rewards program for a key tag finder. The invention is also directed to an e-commerce method of purchasing key tags using the system and method of the invention, along with a locksmith portal for participating certified locksmiths to facilitate the transmission and registration of decoded and or deciphered “advanced”, programmable or traditional keys into the lost key rewards system and method for safe storage. When key loss occurs and that specific key code has been stored within the system of the invention, then the rightful owner can request their key codes to have that individual key duplicated immediately via another participating or non-participating certified locksmith anywhere in the world.

### BACKGROUND OF THE INVENTION

Invariably, key owners lose, misplace or have their keys stolen for automobiles, homes, boats, motorcycles, businesses, elevator fabs, safety deposit boxes, post office boxes, etc., (collectively referred to as “lost keys”). The loss may occur anywhere, for example in the home, airports, hotels, or even in a different state or country. However, depending on the type of keys, duplicating keys can be quite difficult and costly. For example, certain “advanced” keys for automotive, motorcycle, boat or house keys contain electronically stored data which cost anywhere from $200 to as much as $1,500 to replace. These “advanced” keys are generally programmable, comprising of non-metal keys with multi-dimensional surfaces and may further comprise of compressible buttons. They are quite popular with car manufacturers and owners as they provide for automatic electronic access, e.g. to car doors, locking and unlocking a car's steering or ignition, and starting the ignition. Several car manufacturers have different names for these kinds of keys, e.g. Toyota: Smart Key System; Nissan: Intelligent Key; Mercedes-Benz: Keyless Go integrated into SmartKeys. Generally these “advanced” keys are not amenable to being duplicated by a metal key duplicating machine at a general hardware store and the replacement process may also include verifying title and registration as well as a significant wait for replication from the manufacturer. Similarly, traditional key owners may also have to verify title and registration of lost keys and sustain a significant wait for replication from the manufacturer too. However, having a duplicate set of keys does not guarantee that both the original and the duplicate keys won't be simultaneously lost.

Moreover, depending on where the keys are lost, there might be an issue of compromised security. For example, if key loss occurs outside the comfort of one's home, then the challenge becomes finding the keys before a break-in and/or theft occurs or additional costs are incurred for a locksmith. Generally, a key owner will conduct a comprehensive search for the lost keys while invariably hoping that a benevolent key finder, (i.e. finder of lost keys), finds and returns the lost keys. However, in order for a benevolent key finder to return the found keys, the key finder will need the key owner's address and contact information which for obvious security reasons cannot be in the public domain. As such, a benevolent key finder may have the desire to return the found keys but may not have the appropriate contact information to do so. Further, on occasion, a key finder may realize that the keys are pretty valuable and would like to be compensated for finding and returning the lost keys. The alternative is also true, that a key owner may be grateful that the keys have been found and wish to reward the key finder. However, without an exchange of the pertinent contact information from the key finder or key owner, the intent will be frustrated for lack of information and probably will not occur.

Thus, there exists a need for a system and method for returning found keys to their rightful key owners regardless of whether the key owner's contact information is in the public domain. In addition, there exists a need for a system and method available to key owners to register their contact information on a confidential basis such that if their keys are ever lost and found, a finder of the lost keys will have a method of returning the keys without the key owner's confidential information and security being compromised. There also exists a need to allow for a rewards program for key finders providing for the anonymity of the key owner and/or the anonymous key finder as well as a need to fund this lost key rewards system and method.

Both traditional, metal keys and “advanced” keys are capable of being sight decoded for duplication and these key codes can be stored for later retrieval. Thus, there is a need for “advanced”, programmable and traditional key owners to store their key codes in a confidential secure environment for easy retrieval when their keys are lost. Similarly, there exists a need for both anonymous key owners and anonymous key finders to have universal access to a central electronic database such that key owners may register their keys and/or key codes to facilitate their return, regardless of where they are found anywhere in the world.

Many corporations are looking for cost effective ways of promoting their business and increasing the level of customer satisfaction. As the amount of in person contact decreases, businesses have shifted to finding new and innovative services to offer their customers to maintain a competitive edge to resolve that issue. Often, the promotional materials or gimmicks available for giveaways, although attractive, have minimal use to the customer. In addition, these promotional materials can be costly without yielding a sufficient return on the investment. Thus, there is a need for businesses to have a system and method for marketing and advertising their business to improve their customer's satisfaction with the services being offered. This invention satisfies those needs and solves the foregoing problems in a new and novel manner.

### SUMMARY OF THE INVENTION

An objective of the present invention is to provide a lost key rewards system and method for all types of keys, “advanced,” programmable and traditional, so that when a key is lost, the key owner can be readily identified and reunited with their keys in an inexpensive, efficient and effortless manner without disclosure of the key owner's private contact information.

Another objective of the invention is to provide a confidential database for anonymous key owners where the contact information for the anonymous key tag owner is stored and kept private and confidential, such that the identity of the key tag owner is readily identifiable by the system but remains anonymous to an anonymous key tag finder. For purposes of this invention, “a key finder” or “an anonymous key tag finder” is any person who finds a set of lost keys with an attached key tag. This may include a key tag owner who is already a member of the lost key and rewards system and method or a random individual.

Another objective of the invention is to allow key owners who subscribe to the lost key rewards system and method to receive an encoded key tag with a unique key tag number to add to their key chain, where the key tag may have specific instructions and reward incentives for an anonymous key tag finder who finds and returns the lost keys. Said key tags may also be purchased at a brick and mortar store or by a corporation who purchases and distributes the key tags to their client's and/or employees. As such, these individual and corporate owners of the key tags are considered “key tag owners” for purposes of the invention.

Another objective of the invention is to provide a method of doing business where the key tags are sold for a profit which funds the lost key rewards system and method.

Another objective of the invention is to provide a system and method to notify key tag owners that their lost keys were found.

Another objective of the invention is to provide a system and method for an anonymous key tag finder to remain anonymous in the event they find lost keys.

Another objective of the invention is to facilitate gaining access to a secured item, e.g. a boat, car, motorcycle and or home, etc. in the event a key tag owner loses their keys by allowing the key tag owner to store at least one key's decoded key codes and key information that is associated with a unique key tag number with the lost key rewards system and method, such that it can easily be retrieved and transmitted to the key owner and/or locksmith for duplication.

Embodiments provide a system, method, apparatus, means, and computer program code to accomplish these objectives, as the invention uses the Internet to allow global access to a website which has a central electronic database specifically designed to store a key tag owner's information on a confidential basis. A subscribing member of the lost key rewards system and method can elect to purchase a key tag to add to their key chain or ring, whereby each key tag has a unique identifier, e.g. a key tag number that may comprise of numbers, alphanumeric characters, and/or a combination of both, that is used to identify each key tag owner to the system of the invention. It is understood that the key tag may be attached to not just keys, but also elevator fabs, access cards or any other objects that would ordinarily be stored on a key ring or key chain. Each key tag also has information directing an anonymous key tag finder as to where to deposit and/or mail the lost keys for its return to its anonymous key tag owner. In certain embodiments of the invention, the key tag number further comprises of coded or encoded information.

In one embodiment of the invention, the key tag comprises of a locator tracking device embedded in the key tag that is traceable through a locator tracking device using Global Positioning System (“GPS”) technology such that when a key tag owner loses his or her keys, the locator tracking device may be activated for that key tag, such that the keys can be located. In that embodiment, a key tag owner or the system of the invention and/or the customer may activate the locator tracking device embedded within the key tag to track the location of the lost keys such that the geographical position, i.e. longitude and latitude coordinates can be traced and the lost key tag can be located and/or retrieved for the return to the key tag owner. This GPS service may or may not be associated with additional service fees.

In one embodiment of the invention, the system of the invention uses short message service (“SMS”) to communicate with key finders' and key tag owner's cell phones. In that embodiment of the invention, a key tag finders may use SMS text messages to alert the lost key reward system and method of found keys, and to claim a reward, while the system of the invention uses SMS text messages to provide notification and/or status updates to key tag owners of their found keys and/or key tag. SMS text messages are also used for promotional and advertising purposes in conjunction with the invention.

The systems, methods, apparatus, means, and computer program code described herein allow key tag owners to register their contact information with the database of the invention, i.e. name, address, credit card information for purchases, membership, renewals or reactivation fees, which remains confidential and anonymous to an anonymous key tag finder. The system of the invention has instruction code designed to register and store the key tag owner's contact information, as well as further track statistics concerning the key tags, including but not limited to, how many keys tags are lost, stolen, active, inactive, expired, renewable, reactivated, etc.

A key tag owner has the option of reporting their lost keys to the lost key rewards system and method to facilitate their return or they may decide reporting the lost keys is unnecessary for varied reasons. If the key tag owner reports their keys as lost, stolen or misplaced (“loss event”) then the status of the specific key tag will change to reflect a lost key tag with the date of occurrence and whether or not the keys have been found. However, if the key tag owner chooses not to report the lost keys, they may still be returned to the key tag owner even though the loss event was unreported, as the registration of the key tag and/or key codes in the confidential central electronic database is unaffected by the loss event. The system of the invention will still report the key tag in the status (e.g. active or inactive, etc.) it was before the keys were either lost. Therefore, if a key tag owner loses their keys, the key tag owner's information remains private and confidential but an anonymous key tag finder will have a system and method of reuniting the anonymous key tag owner with their lost keys cheaply and with minimal effort.

The lost key rewards system and method also provides for the purchase of additional key tags, whether for the key tag owner's personal use or as a gift, as well as the ability for the key tag owner to manage their account and key tag membership. In one embodiment of the invention, key tag owners are charged a nominal fee for key tag membership, which is renewable each year. In the preferred embodiment, the key tag owner is granted a thirty day grace period before reactivation fees are assessed. In alternate embodiments of the invention, key tag membership is free, but the membership renewal, reactivation and/or the handling fee may be charged to the key tag owner depending on the status of the key tag and if the key tag owner chooses to have their keys and key tag returned or only their keys returned without its specific key tag.

On occasion a key tag owner may own an “advanced” key that is costly and not easily duplicated. The invention allows for such a contingency as an “advanced” key owner who is also a member of the lost key rewards system and method, may register the “advanced” key code(s) with the lost key rewards system and method prior to needing a replacement or duplicate “advanced” key. The “advanced” key owner may have a certified locksmith, who is a co-operative or participating member of the lost key rewards system and method, use a key decoding machine to decipher the key codes or they may physically take apart the “advanced” key to decipher the key codes. In either event, the key codes for a specific key associated with the unique key tag number and key tag owner can be transmitted, received, registered and stored with the lost key rewards system and method for retrieval on an as needed basis.

A co-operative or participating certified locksmith may access the lost key rewards system and method via a locksmith portal which includes a password verification system to authenticate the locksmith and allows the locksmith to submit decoded and/or deciphered key codes. In alternate embodiments of the invention, the co-operative or certified locksmith may or may not be charged a membership fee for participation. The lost key rewards system and method is enabled to receive the key codes from the certified locksmith, via varied receiving means, e.g. mail, scanned entry, hand delivery, facsimile, e-mail, telephone, SMS text messaging, manually, or any other electronic means which allows automatic data transfer directly from the locksmith's key decoding machine to the system of the invention, as well as any other receiving means that are well known and used in the arts.

Upon receipt of the deciphered key codes, the lost key rewards system and method uses the key tag owner's unique identifier to identify the appropriate key tag owner for the proper receipt and storage of the deciphered or decoded key codes for the specific key in a secure and confidential central electronic database. Thus, when an advanced key owner and lost key rewards system and method key tag owner has lost, misplaced or needs a duplicate “advanced” key, the key tag owner may access the lost key rewards system and method to request the stored key codes for the lost “advanced” key.

The lost key rewards system and method in turn receives the request for that “advanced” key codes and upon verification of the identity of the key tag owner is able to transmit the key codes to the key tag owner or a certified locksmith via various transmitting means. The certified locksmith must be a co-operative or participating locksmith in order to access the locksmith portal to transmit decoded and or deciphered information to the lost key rewards system and method. However, a lost key reward member may use any co-operative or non-cooperative locksmith to have their keys replicated from their previously submitted key codes anywhere in the world. Such transmitting means may include but is not limited to mail, scanned entry, hand delivery, facsimile, e-mail, telephone, SMS text messaging, manually, or other electronic means that would transmit the key codes directly from the system of the invention to the certified locksmith's key decoding machine, or any other transmitting means that are well known and used in the arts. In that event, any co-operative or non-cooperative locksmith will have access to the key codes and will be able to duplicate the “advanced” key(s) anywhere in the world providing the certified locksmith has an appropriate key model. In this manner, the advanced key owner is able to gain access to the secured item in a timely, cost efficient manner.

The option to store key information is not limited to “advanced” key owners as key tag owners of regular non-programmable keys may also take advantage of the ability to store their key information, e.g. key codes with the lost key rewards system and method. However, the key information must first be deciphered which can be done in a variety of ways. For example, a non-programmable key may be sight decoded by a locksmith where the locksmith examines the key and deciphers the key's information, e.g. the make, model, year of the secured item, and the key codes that have been cut into the key. In the alternative, the key owner may photocopy the key and either scan, fax, mail, hand deliver, telephone, email, SMS text message or use any other transmitting means which allow for data transfer to transmit the key information to the system of the invention. However, it is well known in the arts that replication of a non-programmable key using a photocopied version of the key is only about 80-85% accurate. As such, this method of replication is optional, but not the preferred method as preferably, the key tag owner will have at least a tangible key model to replicate.

In an alternate embodiment, the key codes may be deciphered with a decoding key machine. Once the key codes are deciphered they may be transmitted and stored with the lost key rewards system and method for retrieval on an as needed basis using any of the transmitting means or other electronic means previously mentioned that are well known and used in the arts.

According to the system and method of the invention, if a key tag owner purchases a key tag for themselves or as a corporate customer, unless the key tag has been replaced or destroyed, the key tag will remain registered to the individual key tag owner even after the key tag has expired. Thus, if a key tag is found after its membership has expired, which in the preferred embodiment is one year with a grace period of thirty days, the key tag owner may still be identified and notified of the found keys. The key tag owner can then elect as to whether or not they wish to have the keys and key tag returned with the payment of any applicable fees, e.g. renewal and/or reactivation fees or they may choose to have only their keys returned without any renewal and/or reactivation fees. Depending on the option selected, a shipping and handling fee may apply.

Another objective of the invention is to receive payment from a co-operative locksmith for a membership fee for their participation as a certified locksmith. In that case, a certified locksmith will be able to manage their contact and credit card information to provide updated information as necessary.

Another objective of the invention is to allow both regular and corporate customers the ability to apply a coupon or promotional code for discount purchases.

Another objective of the invention is to allow for the return of found keys by an anonymous key tag finder to an anonymous key tag owner.

Another objective of the invention is to allow corporations to incorporate the lost key rewards system and method as part of their employee or customer reward and incentive programs, while deriving profit without much expenditure.

Another objective of the invention is to provide a corporate entity with the means to advertise a company's logo and contact information on corporate key tags such that the corporate entity is establishing brand identity, marketing their goods and/or services while improving customer satisfaction.

To accomplish these business objectives, the lost key rewards system and method provides for a partnership with corporate entities. One of the benefits of this type of partnership is allowing corporate customers to purchase key tags at a discounted rate where the key tags may be customized with the company logos and/or targeted messages, to receive corporate newsletters, and/or enjoy other promotional programs that are specifically geared for their corporate customers. In an alternate embodiment of the invention, the corporate entity may purchase and distribute the key tags as a promotional item or part of their rewards program to their corporate customers without deriving any profit from the sale and/or distribution.

In that embodiment, the corporate entity may distribute a corporate passcode for their corporate customers' use while the lost key rewards system and method handles the administration of the lost key rewards system and method. The corporate customers may then, use their corporate passcode to access the lost key rewards system and method to purchase a key tag or perform any other function as an individual key tag owner.

For a further and more fully detailed understanding of the present invention, various objects and advantages thereof, reference is made to the following detailed description and the accompanying drawings.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1A is network diagram that illustrates an embodiment of the system of the invention.

FIG. 1 is a schematic illustration of the e-commerce transaction of purchasing a key tag using the invention.

FIG. 2 is a schematic illustration of an e-commerce transaction for purchasing a key tag as a gift using the invention.

FIG. 2A is a schematic illustration of the varied functions that a key tag purchaser may perform after purchasing a key tag as a gift using the invention.

FIG. 3 is a schematic illustration of the varied functions that a corporate customer may perform using the invention.

FIG. 4 is a schematic illustration of e-advertising to generate e-commerce transactions using the invention.

FIG. 5 is a schematic illustration of the varied functions that an individual key tag owner may perform using the invention.

FIG. 6 is a schematic illustration of how to report my lost and found keys using the invention.

FIG. 7 is a schematic illustration of how to check the status of lost keys using the invention.

FIG. 8 is a schematic illustration of the method for the return of found keys and/or key tags using the invention.

FIG. 9 is a schematic illustration of how to renew a key tag membership using the invention.

FIG. 10 is a schematic illustration of how to reactivate an expired key tag using the invention.

FIG. 11 is a schematic illustration of how to request a replacement key tag using the invention.

FIG. 12 is a schematic illustration of how to invite friends to become members using the invention.

FIG. 13 is a schematic illustration of how a key tag owner may update their contact information using the invention.

FIG. 14 is a schematic illustration of how a key tag owner may cancel their key tag membership using the invention.

FIG. 15 is a schematic illustration of how an anonymous key tag finder may report found keys using the invention.

FIG. 16 is a schematic illustration of how a key tag owner may update their credit card information and membership information using the invention.

FIG. 17 is a schematic illustration of a method of registering key codes using the invention.

FIG. 18 is a schematic illustration of a method of gaining access to a secured item using the invention.

### DESCRIPTION OF PREFERRED EMBODIMENTS

The present invention is now described in more detail by reference to the exemplary drawings in detail wherein like numerals indicate like elements throughout the various views. This is for convenience only and is not intended to limit the application of the present invention. In fact, after reading the following description, it will be apparent to one skilled in the relevant art(s) how to implement the following invention in alternate embodiments.

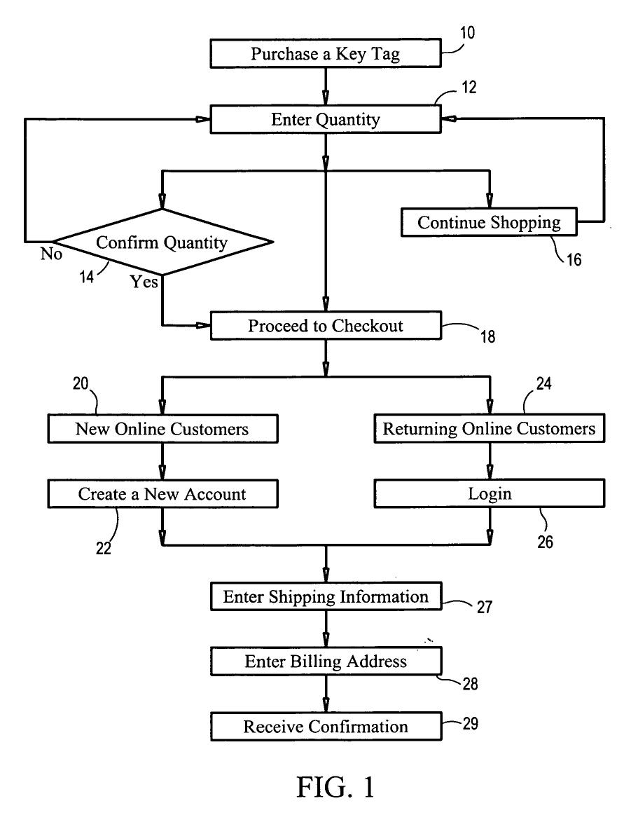

FIG. 1A is network diagram that illustrates an exemplary embodiment of the system of the invention. A customer may access the system of the invention via Internet 256 by way of communication paths 243, 245 using their web access device, e.g. game boy, PDAs, I-Phones, BlackBerry®, smart phones or personal computer 244, 246 which has a keyboard 248, 250 and monitor 252, 254 for entering and displaying information. When a customer accesses the lost key rewards system and method via the Internet 256 which is in communications with the server 262, the system of the invention may communicate with the lost key rewards customer via a similar communication path 263 as previously described. Said communication paths 243, 245 may include but is not limited to wireless transmissions, fiberoptics, radio frequency transmissions, or any other communication paths that are well known and used in the arts to communicate with the Internet 256. The server 262 environment of the invention also comprises of a an operating system 258 (not shown), a central processor 242 (not shown) and a memory device 260 (not shown) where the central electronic database 247 (not shown) is used to store information concerning each key tag, the key tag owner, credit card information, membership status information and the like, as discussed in further detail below.

The memory device may be any computer-readable media such as storage devices, such as a hard drive, a CD-ROM, and/or floppy disk drive, flash drives or any other media devices as used in the arts and may contain instruction code for implementing the lost key reward system are well known and used in the arts. The central processor 242 (not shown) of server 262, is in further communications with a central electronic database 247 (not shown) which is a part of the memory device 260 (not shown). The central processor 260 (not shown) is configured to perform the following activities which may include but is not limited to performing e-commerce transactions, receiving and storing data, performing searches, etc. Also, one skilled in the art will appreciate that various communication channels can be used to interconnect the web server and the customers' personal computer 244, 246 such as the Internet 256, a wide area network, or point-to-point, dial-up connections, cable network, fiberoptics, and DSL hi speed connections.

FIG. 1 is a schematic illustration of the e-commerce transaction of purchasing a key tag using the invention. A customer may access (Step 8, not shown) the lost key rewards system and method via a world wide website portal designed to perform inter alia, the e-commerce transaction of purchasing a key tag as in Step 10. As in any e-commerce transaction involving a quantitative sale, the individual and/or corporate customer must select the quantity for purchase as in Step 12 and the system of the invention will tabulate the cost for the quantity selected. In one embodiment of the invention, there is a cost incentive for purchasing multiple key tags, e.g. buy 3, get 1 free. In another embodiment of the invention, the customer may enter a coupon or promotional code (Step 6, not shown) to receive a discount on the key tag(s) being purchased. In an alternate embodiment of the invention, a key tag owner may purchase the key tag from a storefront or received the key tag as a gift both with temporary passwords, and still be able to participate in the lost key and rewards system. In other embodiments, a corporate entity purchases the key tags and distributes the purchased key tags to its corporate customers. In these embodiments, each key tag will have a temporary password for logging into the lost key rewards system and method. Thereafter, the key tag owner may add all their contact and credit card information for future reference.

If the customer is satisfied with the quantity selected, the customer may proceed directly to checkout their purchases as in Step 18, or continue shopping as in Step 16, in which event the customer will return to Steps 12-18. If the customer is dissatisfied with the quantity selected, the customer may confirm their purchase as in Step 14, which may involve the addition or removal of key tags from the shopping cart (Step 13, not shown), or editing the quantity selected (Step 15, not shown) to either increase or decrease the number of key tags being purchased.

Once the customer is ready to checkout as in Step 18, if this is a new online customer, additional information will be required in order to consummate the sale, i.e. the customer must register their contact information with the central electronic database 247 of the invention. As such, the customer must identify him or herself to the central electronic database 247 as a new online customer as in Step 20 and the customer will be required to create a new account as in Step 22. To create a new account (Step 22) the new online customer will need to provide their contact information, e.g. name, address, mailing address, telephone numbers, and e-mail address, etc. In addition, all new customers will be required to create a unique userid and password that will be used to authenticate the customer for subsequent logins via a password verification system that is well known and used in the arts. In one embodiment of the invention, in creating a new account the customer is prompted to provide the email addresses of friends that they would like to invite to join (Step 90, not shown) the lost key rewards system and method. In yet another embodiment of the invention, the customer is polled for marketing and/or demographic information, e.g. the referral source, age, entertainment preferences, etc.

If the customer is a returning online customer, the customer must identify themselves as such, as in Step 24, and will need to login as in Step 26 using the password verification system to access their saved information. Once the customer has either completed the creation of a new account (Step 22) or logged in (Step 26) as a returning customer, they may proceed to enter their shipping information (Step 27), e.g. name, shipping address, express, first class, priority or any other type of mail delivery service. In one embodiment of the invention, the customer can elect to have their key tag membership renewed via automatic subscription (Step 190, not shown) with the lost key rewards system and method as they provide their shipping and/or billing information. If the billing information differs from the shipping information, as is customary, the customer must provide the billing information as in Step 28. The billing information would include, inter alia, name, type of credit card name, billing address, expiration date, etc. and other like information for e-commerce transactions. Once Steps 27-28 are complete, the customer may proceed to receive confirmation (Step 29) of the purchase order. In an alternate embodiment of the invention, the customer may have an opportunity to enter a coupon or promotional code (Step 6, not shown) during the checkout process (Steps 27-28) to receive a discount on the key tag(s) being purchased.

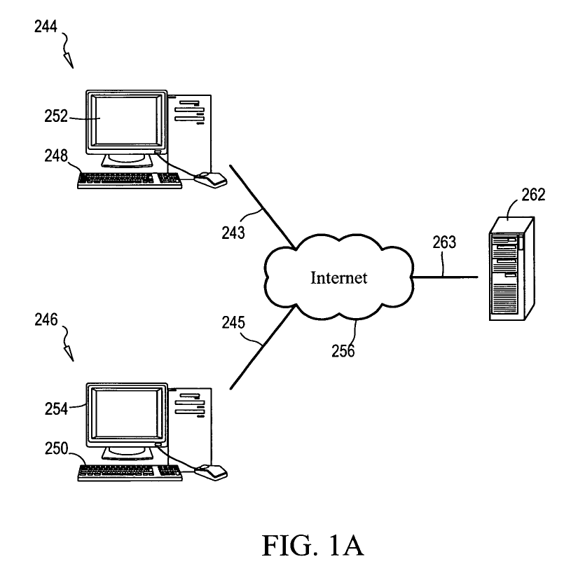

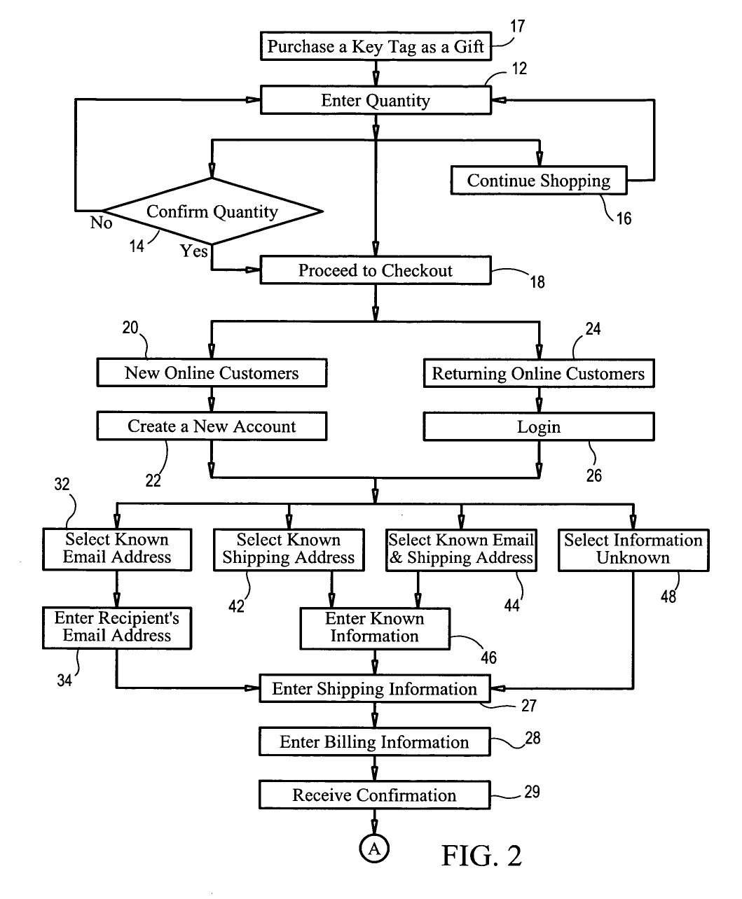

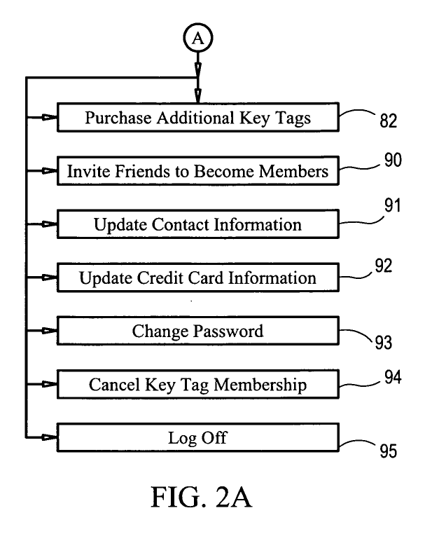

FIG. 2 is a schematic illustration of an e-commerce transaction for purchasing a key tag as a gift using the invention. Any customer, new or returning, may access (Step 8, not shown) the lost key rewards system and method via the Internet 256 to purchase key tags as a gift (Step 17) for a third-party. The customer will be prompted to repeat Steps 12-26 of FIGS. 1 & 2. In addition, the customer must provide a shipping address for the gift. However, it is not unusual that a gift donor has limited or no address information for a gift recipient. The invention provides for such contingencies as it allows the donor to provide known information from which there is a means for informing the gift recipient of the gift, or in the alternative have the gift key tag(s) shipped to the donor for delivery if the customer selects the option that the gift recipient's information is unknown (Step 48).

For example, if the donor knows only the email address for the gift recipient, the donor must inform the lost key rewards system that only the gift recipient's email address is known as in Step 32, proceed to enter the gift recipient's email address as in Step 34 and enter the donor's shipping information as in Step 27, which may include, but is not limited to the donor's address, type of shipping method, etc. Thereafter, the donor may provide their billing information (Step 28) if different from the shipping address. After Steps 27-28 are complete, the donor may proceed to receive confirmation (Step 29) of the purchase order. In the preferred embodiment, the gift recipient is notified by an email of the gift and/or the identity of the donor and is provided with a temporary userid and password such that the gift recipient may access the website (Step 8, not shown) and provide their own contact information to receive the gift key tag or to perform other select functions that a key tag owner may perform as a member of the lost key rewards system and method as seen in FIG. 2A.

FIG. 2A is a schematic illustration of the varied functions that a donor may perform after purchasing a gift key tag using the invention. For example, the donor may purchase additional key tags as in Step 82; invite friends to become members as in Step 90; update their contact information as in Step 91; update their credit card information as in Step 92; change their password as in Step 93; cancel their key tag membership as in Step 94; or logoff as in Step 95. The aforementioned Steps 82-95 of FIG. 2A will be described in further detail below.

Referring back to FIG. 2, if the donor knows the shipping address of the gift recipient, or both the email and shipping address of the gift recipient, the donor may select the applicable option as in Step 42 (select known shipping address) or Step 44 (select known email and shipping address), respectively, and proceed to enter the gift recipient's known information as in Step 46 which may also include the gift recipient's telephone number. Additionally, the donor will need to enter the shipping and billing information, if different as in Steps 27-28, respectively. Once the shipping and billing information is verified, the donor may receive confirmation (Step 29) of the purchased gift key tags.

If the donor has no address information for the gift recipient, i.e. neither email nor a shipping address, the donor must inform the lost key rewards system and method that the gift recipient's information is unknown as in Step 48, and enter their own shipping and billing information as in Steps 27-28, or some other appropriate shipping and billing information for the receipt of the gift. Once the donor verifies the shipping and billing information, the donor may receive confirmation (Step 29) of the purchased gift key tags.

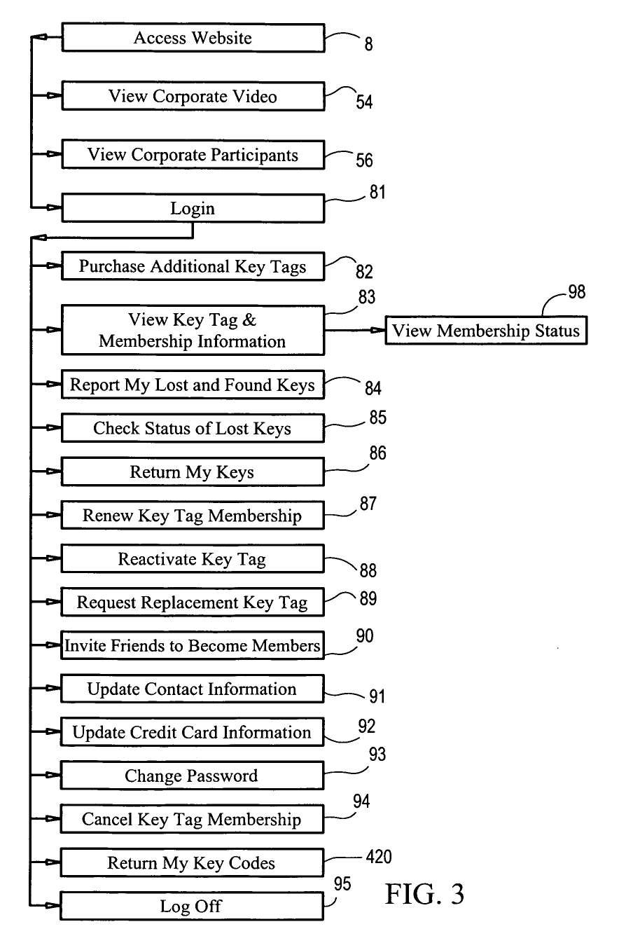

FIG. 3 is a schematic illustration of the varied functions that a corporate customer may perform using the invention. The corporate rewards program allows a corporate entity to partner with the lost key rewards system and method such that the corporate customers can participate as members. In one embodiment of the invention, the corporate entity may purchase a select number of key tags, possibly at a discount for distribution to their employees, existing or potential customers (collectively “corporate customers”). By purchasing the key tags at a discounted rate, the corporate entity may either pass on the savings to the corporate customers or derive revenue by charging the corporate customers full price. In another embodiment, the corporate entity distributes free key tags to their corporate customers with a temporary password for each key tag that allows for logging in to the lost key rewards system and method. There, the corporate customer may or may not have to enter their contact information depending on whether the corporate entity has already provided the same to the lost key rewards system and method.

In another embodiment of the invention, the corporate entity distributes a corporate passcode to its corporate customers that is unique to that corporate entity. The corporate passcode serves to identify these corporate customers to the lost key rewards system and method such that they can receive any negotiated promotional corporate rate for their key tag purchases, customized corporate information and updates, e.g. newsletters, and any other promotional or advertising materials specifically tailored for those corporate customers.

Once the corporate customer has accessed the website as in Step 8, the corporate customer may view corporate video (Step 54) or view other corporate participants (Step 56) to learn more about the lost key rewards system and method. The corporate video may contain customized promotional and marketing information for that corporate participant, e.g. corporate rates, discounts, amounts purchased, or any other confidential information, that their clients would not be privy to. In the preferred embodiment, access to the corporate video is limited to an “as needed basis,” i.e. Marketing Executive(s), Vice Presidents and/or Chief Operating Officer, where these select individuals must have a specific passcode which will be verified by the system of the invention prior to their gaining access to the confidential information.

As seen in FIG. 3, any lost key rewards existing or potential customer, including an individual or corporate customer, may access the website (Step 8) and view a list of other corporate participants (Step 56) who have partnered with the lost key rewards system and method and may have the option of linking to that corporate participant's website from the system of the invention. Some corporate participants may choose not to be listed. In that event their names or contact information will not be displayed by the system of the invention.

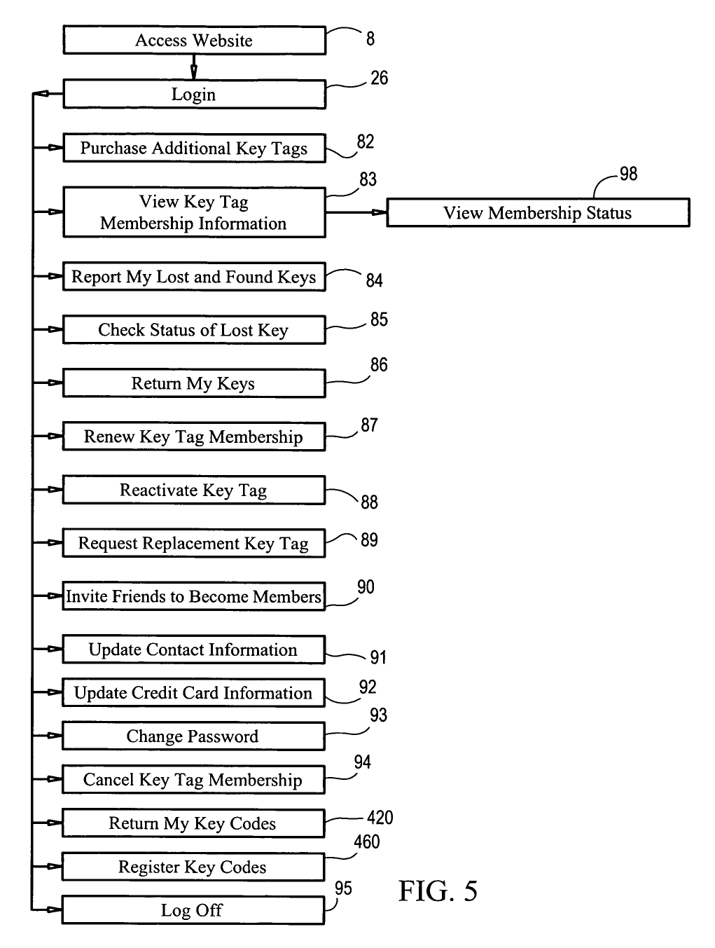

A corporate customer may also login using the corporate passcode (Step 81); purchase a key tag (Step 10, not shown); purchase additional key tags (Step 82); view their key tag membership information (Step 83); view membership status information (Step 98); report my lost and found keys (Step 84); check status of lost keys (Step 85); return my keys (Step 86); renew key tag membership (Step 87) with the lost key rewards system and method; reactivate an expired key tag (Step 88); request replacement key tag for a damaged key tag (Step 89); invite friends to become members (Step 90); update their contact information (Step 91); update credit card information (Step 92); change their password (Step 93); cancel their key tag membership (Step 94); request return of my key codes (Step 420), logoff (Step 95), or register a corporation (Step 422, not shown). These steps will be explained in further detail below and in conjunction with FIG. 5 which illustrates similar functions that an individual key tag owner may perform using the invention as like referenced numbers refer to like elements throughout.

The invention allows a prospective corporation who is interested in partnering with the lost key rewards system and method to register the corporation (Step 422, not shown) by providing the corporation's contact information and inquire further as to how to become a corporate participant. Once the corporation's contact information is submitted, the lost key rewards system and method uses that information to contact the corporation and follow up with all necessary procedures and agreement to execute that arrangement.

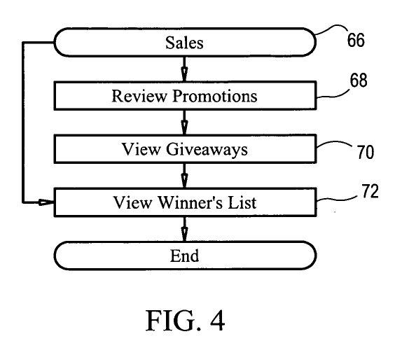

FIG. 4 is a schematic illustration of e-advertising to generate e-commerce transactions using the invention. The lost key rewards system and method provides the means for e-marketing and e-advertising using the invention. In that regard, the lost key rewards system and method will have periodic sales promotions in which the key tag owners can participate to win prize giveaways. The lost key rewards customer may be notified by an SMS text message to their cell phone or via email of certain promotional advertisement, notices and prize giveaways or by logging in to the system of the invention. In one embodiment of the invention, all key tag owners are eligible for random periodic drawings and as such, no further action is needed for a key tag owner to participate as an entrant in the prize giveaways.

In another embodiment of the invention, if the key tag owner wishes to participate in the promotional giveaways, the key tag owner must affirmatively opt into the random drawing. As such the key tag owner may select the sales option as in Step 66, review the promotions as in Step 68 and view the available prize giveaways as in Step 70. The key tag owner then enters their key tag number(s) as in Step 71 (not shown) that are eligible for the random drawing. Notwithstanding, in both embodiments the system of the invention will randomly select a winner from the entrants and notify the key tag owner/winner that they have won a prize which may include a television set, laptop, cash, or any other prize giveaways. In doing so, the key tag owner may be contacted and their picture and/or other information uploaded to the lost key rewards system and method for publication on the winner's list. To learn if a key tag owner won a prize, the key tag owner simply views the winner's list as in Step 72 where the winner's name and or picture would be published.

FIG. 5 is a schematic illustration of the varied functions that an individual key tag owner may perform using the invention. After accessing the website as in Step 8, similar to a corporate customer, the individual key tag owner may view corporate video (Step 54, not shown) or view other corporate participants (Step 56, not shown). The individual key tag owner may also login (Step 26) to the system of the invention; purchase additional key tag(s) (Step 82); view their key tag membership information (Step 83); view membership status information (Step 98); report my lost and found keys (Step 84); check status of lost keys (Step 85); return my keys (Step 86); renew their membership with the lost key rewards system and method (Step 87); reactivate an expired key tag (Step 88); request replacement key tag for damaged key tag (Step 89); invite friends to become members (Step 90); update their contact information (Step 91); update credit card information (Step 92); change their password (Step 93); cancel their key tag membership (Step 94); register key codes (Step 460) with or without help of participating locksmith, or request the return of key codes (Step 420); or logoff (Step 95).

By using a password verification system that is well known and used in the arts, the key tag owner can change their password as in Step 93 of FIG. 5 in a manner that is well known and used in the arts.

If a key tag owner wishes to purchase additional key tags (Step 82), the key tag owner will need to provide the system of the invention with the quantity, shipping and billing information to complete this e-commerce transaction and follow the Steps enumerated in Steps 10-29 of FIG. 1.

As seen in FIG. 5, a key tag owner may view their key tag membership information Step 83 using the invention. Once the key tag owner submits the request to view their key tag membership information (Step 83), the system of the invention will display all key tags owned by that key tag owner identifying each key tag by its unique key tag number. The key tag owner may then view the membership status information (Step 98) which may comprise of such information as the key tag number, purchase date, the expiry date for the key tags, renewal dates for membership, reactivation dates and/or the status of each key tag, i.e. active, expired, lost, stolen or cancelled. For example:

| Key Tag | Purchase | | Renew On/ | Reactivation | |
|---|---|---|---|---|---|
| Number | Date | Expiry Date | Before Date | Date | Status |
| VSML-000-01 | Jul. 8, 2007 | Jul. 8, 2008 | Aug. 8, 2008 | Aug. 9, 2008 | Active |
| VSM-000-004 | Jul. 12, 2007 | Jul. 12, 2008 | Aug. 12, 2008 | Aug. 13, 2008 | Lost |
| VSML-00-007 | Jul. 13, 2007 | Jul. 13, 2008 | Aug. 13, 2008 | Aug. 14, 2008 | Stolen |
| MLA-02-0089 | Jul. 13, 2007 | Jul. 13, 2008 | Aug. 13, 2008 | Aug. 14, 2008 | Cancelled |

Each key tag purchased may include a free one year membership with the lost key rewards system and method. In one embodiment of the invention, the first year of membership may be free while in an alternate embodiment the membership fee is a nominal amount. The expiry date of the key tag is the effective date from which the one year membership renewal date will be calculated. The lost key rewards system and method allows the key tag owners one year and thirty days within which to renew their membership without penalty for an expired key tag. If the key tag owner wishes to renew a key tag membership which has past the one year and thirty days date to renew, then the key tag owner will be charged a reactivation fee. Hence, a key tag owner may self-monitor their membership information taking notice of the renewal and reactivation dates to avoid unnecessary costs.

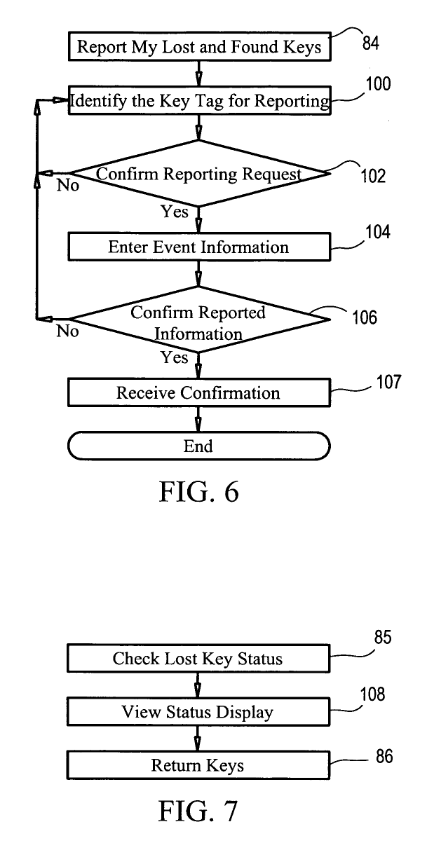

FIG. 6 is a schematic illustration of how to report my lost and found keys using the invention. After accessing the website (step 8, not shown) a key tag owner may opt to report lost keys (Step 84) associated with a particular key tag number as lost and/or stolen to facilitate their return. Quite often, “lost” keys are simply misplaced as the owner soon finds their own keys after a more careful search. The system of the invention provides for such a contingency as the key tag owner may also report their own keys as found (Step 84). On occasion a key tag owner may decide not to report the lost keys (Step 84) for a variety of reasons. However, not reporting the loss event does not affect the ability of their keys being found and/or returned to the key tag owner by the lost key rewards system and method. Even though a key tag may be lost, the system of the invention will continue to show this key tag in its current membership status as to whether it was active or expired prior to the loss event.

If the anonymous key tag owner decides to report their lost, stolen or found keys as in Step 84, the system of the invention will provide a status display for all key tags owned by this key tag owner. The key tag owner must identify and select the specific key tag number for reporting as in Step 100. The key tag owner may also review and confirm that the correct key tag has been selected as in Step 102 prior to proceeding further with reporting the loss or found event. If for any reason an incorrect key tag was selected, the key tag owner may cancel the reporting of that key tag and the key tag owner will be directed back to Step 100 where they may select the correct key tag for processing via Steps 100-102. If the correct key tag was selected (Step 102), then the key tag owner may continue with the reporting by entering the loss or found event information as in Step 104, i.e. whether the keys were lost, stolen or found and at least the date that event occurred. The system of the invention has sufficient protocols and controls to ensure that a date later than the current date cannot be entered as an event date for a lost key tag. Once again, the key tag owner must confirm the reporting as in Step 106 prior to the central electronic database 247 of the invention storing the event information. This extra confirmation step provides a second opportunity to cancel the reporting, in which event, the key tag owner will be directed to Step 100 to follow the steps enumerated in Steps 100-106. However, if the key tag owner is satisfied that the reported information is correct, the key tag owner may proceed to receive confirmation (Step 107) that the loss or found event was reported. Once reported as lost and/or stolen, if the key tag has an embedded locator tracking device, the system of the invention may use GPS technology to activate the tracking device to locate the lost key tag, such that the lost keys and key tag may be retrieved for the anonymous key tag owner.

FIG. 7 is a schematic illustration of how to check the status of lost keys using the invention. As seen in Step 85, a key tag owner may conduct a realtime status check for their lost keys and/or key tag for all applicable key tags owned by the key tag owner. The key tag owner may view the status display (Step 108) to determine whether their keys associated with a specific key tag have been found, remained lost, already retrieved from the key tag finder, or, are in the process of being retrieved from the key tag finder.

If an anonymous key tag finder has already reported the lost key tag and/or keys (Step 163, not shown) as found to the lost key rewards system and method, the system of the invention will automatically update its records and database 247 in realtime to reflect that the lost key tag has been found. In that event, when the key tag owner checks the status for the lost keys (Step 85), the key tag will be reported as being in the process of being retrieved from the anonymous key tag finder, or some other like notification of similar content and import. The system of the invention may also provide an automatic email notification, and/or SMS text message, hand delivered message, telephone call, facsimile message; or send a letter by regular mail to the key tag owner notifying the key tag owner in realtime as soon as the key tag finder registers the key tag as found with the lost key rewards system and method.

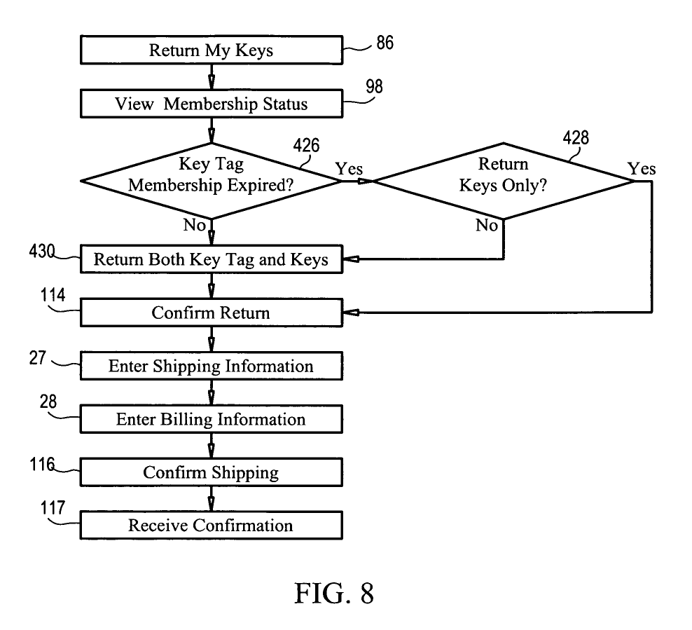

If the keys have not been found and/or retrieved from a key tag finder prior to the key tag owner checking the status of the lost keys, the system of the invention may provide notification to the key tag owner via SMS text message, e-mail, and/or static display indicating that the keys have not been found, or some other notification of like content and import. Once the keys and/or key tag have been received from the key tag finder but not yet returned to the key tag owner, the key tag will be reported as having been retrieved, or some other message of similar content and import and in addition, the key tag will be flagged for return to the key tag owner. If the key tag and/or keys are flagged for return, the key tag owner may proceed to process the request to have their keys and/or key tag returned as in Step 86 as seen in FIG. 8.

FIG. 8 is a schematic illustration of the method for the return of my found keys and/or key tags using the invention. A key tag owner may choose if they want to have their keys and its attached key tag returned to them or only have their keys returned without the key tag, while taking into consideration any fees that may be associated with either choice depending on the status of the specific key tag. In one embodiment of the invention, the return of lost keys is a free membership benefit and the key tag owner only pays for the shipping and handling for returned keys which is determined by the system of the invention.

Once the anonymous key tag owner elects to have their keys returned as in Step 86, the system of the invention receives the request for the return of the found keys and automatically provides an updated status display of their key tag membership information. The key tag owner may then view their key tag status information (Step 98) to determine if the key tag membership is active, needs to be renewed, or needs to be reactivated. If the key tag's membership has not expired (Step 426) and the key tag is current and active, the key tag owner may proceed to request the return of both the key tag and keys (Step 430), and confirm the return request (Step 114). In the preferred embodiment, there are no return key fees, but the key tag owner may have to pay shipping and handling fees as determined by the system prior to the return of the found keys and/or key tag. As such, the key tag owner may simply provide their shipping (Step 27) and billing information (Step 28) if necessary, for any applicable shipping and handling fees. The key tag owner may confirm the shipping information (Step 116) and receive confirmation (Step 117) of the same.

If the key tag's membership has expired or is inactive (Step 426), the key tag owner may choose the return of their keys only (Step 428) without the expired or inactive key tag. Then the key tag owner may proceed to confirm the return request (Step 114) of the keys only and follow Steps 27 through 117. If however, the key tag owner wants the return of both the expired or inactive key tag (Step 430) and keys, the key tag owner may confirm the return request (Step 114), pay the renewal or reactivation fee (Step 431, not shown) plus any additional shipping and handling fees that may apply prior to their key tag and keys being returned. Accordingly, the key tag owner will need to provide their shipping (Step 27) and billing information (Step 28) and proceed to follow Steps 27-117.

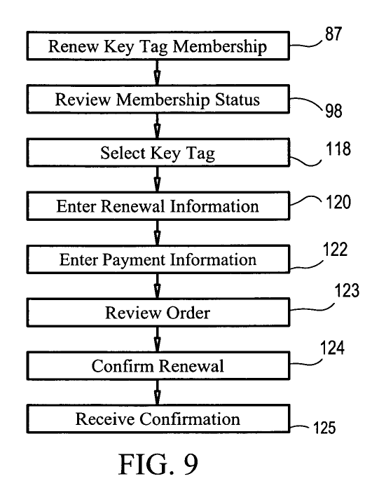

FIG. 9 is a schematic illustration of how to renew a key tag membership using the invention. A key tag will be eligible for renewal at anytime prior to the expiration date, i.e. before the one year and/or any applicable grace period have expired. The key tag owner may opt to renew their membership as in Step 87 and the system of the invention will automatically display their membership status information for their review.

The key tag owner may then review the membership status information as in Step 98 for the expiry and renewal dates for each key tag owned. Although a key tag owner may own multiple key tags which may have been purchased simultaneously, and thus expires at the same time, a key tag owner can limit their renewal to one or more key tags. To do so, the key tag owner may select the specific key tag(s) (Step 118) that they wish to renew its membership and proceed to enter the renewal information (Step 120), e.g. number of years to be renewed. Once Step 120 is completed, the key tag owner may enter the payment information (Step 122) for any applicable renewal fees, review the entered payment information (Step 123) and confirm the renewal as in Step 124. If the key tag owner is satisfied with the renewal request, the key tag owner may proceed to receive confirmation of the renewal as in Step 125.

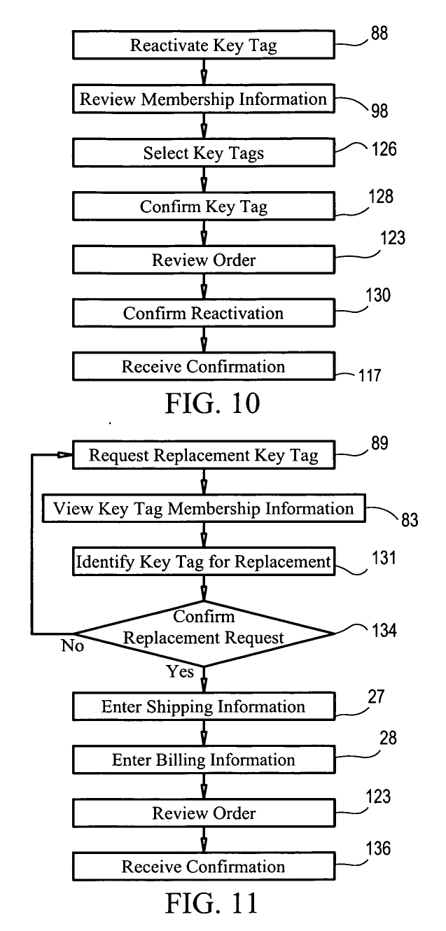

FIG. 10 is a schematic illustration of how to reactivate an expired key tag using the invention. In the preferred embodiment, after the one year and thirty day grace period have elapsed, a key tag owner may reactivate a key tag's membership (Step 88) by paying any applicable reactivation fee if the key tag owner wishes to have the specific key tag reflected as in “active” status. It is not mandatory for the key tag owner to reactivate this specific key tag (Step 88) to remain functional in the lost key rewards system and method. However, when the lost key tag and keys are found, the key tag owner may choose to pay the applicable renewal, reactivation, shipping and handling fees to have their keys and its specific key tag returned, if that key tag was not previously reactivated by the key tag owner. Similar to renewing a key tag's membership (Step 87), a key tag owner may own multiple key tags that may have expired but still limit the reactivation to one or more key tags.

A key tag owner may reactivate an expired key tag as in Step 88 by reviewing their membership status information as in Step 98 for accuracy, and affirmatively select the key tag(s) being reactivated (Step 126). Once Step 126 is completed, the key tag owner must confirm the reactivation request (Step 128) for the specified key tags and enter the payment information as in Step 129 (not shown). After the payment information has been entered (Step 129, not shown), the key tag owner must review the order (Step 123) and confirm the accuracy of said information (Step 127, not shown). Prior to finalizing the transaction, the key tag owner is required to again confirm the reactivation (Step 130) of the specified key tag(s) prior to receiving confirmation of the same (Step 117).

FIG. 11 is a schematic illustration of how to request a replacement key tag using the invention. A key tag owner may request a replacement key tag (Step 89), which in one embodiment of the invention will be free of charge. In an alternate embodiment, the key tag owner will be charged for a replacement key tag. The key tag owner must first review the key tag membership information as in Step 83 for all key tags owned to identify and select the key tag being replaced (Step 131). Since the key tag number is unique, linked as an identifier to the key tag owner, and used to track membership information, once the key tag owner reports the key tag as damaged, it is desirable that this key tag number be flagged by the system of the invention as being replaced, if not totally eliminated from the system of the invention, such that it can never be reused. Accordingly, prior to the key tag owner replacing the key tag, the key tag owner must confirm the replacement request (Step 134) for the selected key tag.

If the key tag owner chooses to cancel the replacement request, then the system of the invention will abort the replacement request and direct the key tag owner to Step 89 to request the replacement of the correct key tag number. In the alternative, if the key tag owner wishes to continue processing the replacement request, the key tag owner must enter their shipping and billing information in accordance with Steps 27-28 of FIGS. 1 & 11. The key tag owner will be allowed at least one other opportunity to review the order request (Step 123) for a replacement key tag, and if satisfied with the request, proceed to receive confirmation of the replacement request as in Step 136.

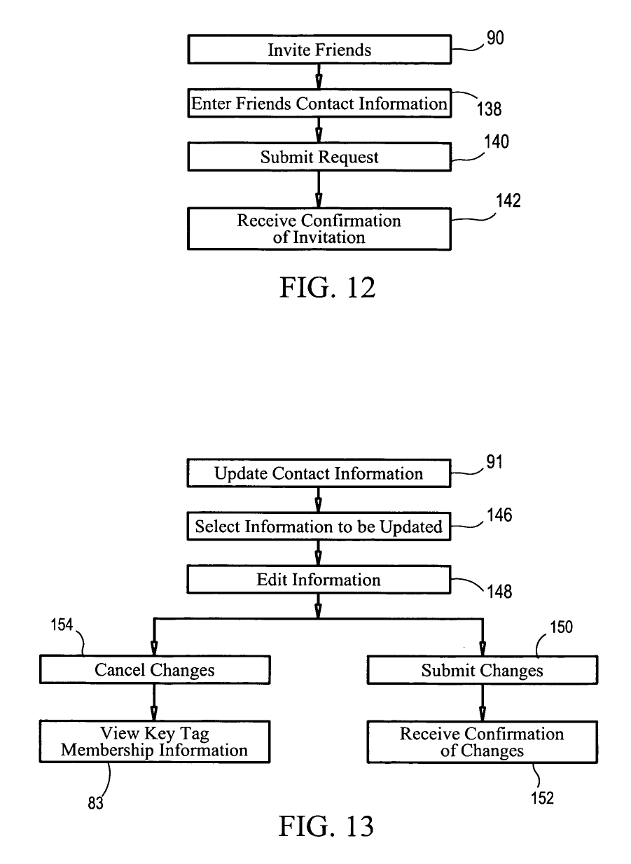

FIG. 12 is a schematic illustration of how a key tag owner may invite friends to become members using the invention. As seen in Step 90, a key tag owner may choose to invite friends to become members of the lost key rewards system and method by entering their friends contact information (Step 138), which may include one or more of the following: name, email address, address, telephone numbers, etc. In one embodiment of the invention, for each friend who elects to become a member, the referring key tag owner receives a promotional incentive, e.g. an additional 30 free days added to one of their key tag's membership, or extra chances to participate in promotional giveaways. In an alternate embodiment of the invention, if the key tag owner owns multiple key tags, the key tag owner will receive an additional number of free days added to key tag membership with the least amount of days remaining prior to expiration.

Once Step 138 is complete, the key tag owner may submit the request as in Step 140 and receive confirmation of the invitation(s) as in (Step 142). In one embodiment of the invention, the key tag owner may choose to cancel the request (Step 143, not shown), in which event the key tag owner will receive confirmation of the cancellation request as in Step 144 (not shown). In an alternate embodiment, the key tag owner may elect to omit or remove their friends' contact information, in which event the lost key rewards system and method will provide notification that none of their friends have been invited or some other notice of like content and import. This aborted attempt does not preclude the key tag owner from accessing the lost key rewards system and method at a later date to invite their friends to participate as members of the invention.

FIG. 13 is a schematic illustration of how a key tag owner may update their contact information using the invention. Both the regular and corporate key tag owner may update their contact information as in Step 91, to ensure that the information being stored on the lost key rewards system and method is current and accurate. As seen in FIG. 13, the key tag owner may select the relevant portion(s) of their contact information (Step 146) that needs to be updated, e.g. email address, name, address, telephone numbers and/or facsimile numbers, or any other relevant contact information. Once selected, the key tag owner may proceed to edit the information as in Step 148. After editing the information (Step 148), and if the proposed changes are correct, the key tag owner may submit the changes as in Step 150 and receive confirmation (Step 152) that the changes were successfully entered. In the alternative, if the key tag owner wishes to cancel or abort the changes at this time, they may do so by canceling the changes as in Step 154 and the system of the invention will direct them to a screen where the key tag owner may view their key tag membership information as in Step 83 for further review.

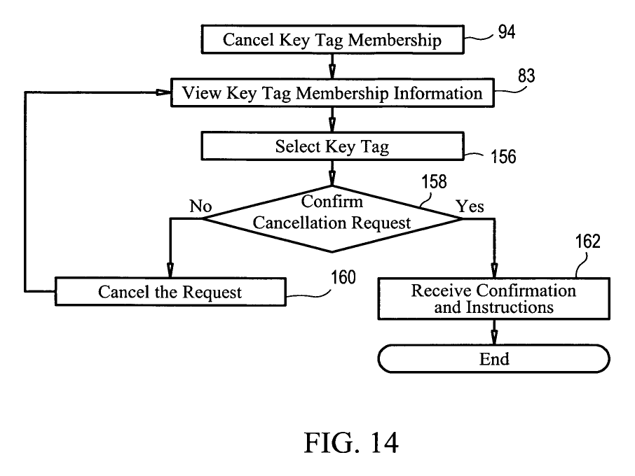

FIG. 14 is a schematic illustration of how a key tag owner may cancel their key tag membership using the invention. A key tag owner may cancel their key tag's membership with the lost key rewards system and method without any penalties within the first thirty days after purchasing the key tag. In that event, upon cancellation of the key tag purchase, the key tag membership and purchase fees will be returned to the key tag owner, but not the shipping and handling costs. It is understood that returns and/or cancellations without penalty may be allowed beyond thirty days to conform to international and state laws. As seen in Step 94, the key tag owner can elect to cancel his or her membership for individual key tags. The system of the invention will direct the key tag owner to where the key tag owner may view their key tag membership information as in Step 83. There the key tag owner must identify and select the specific key tag(s) (Step 156) for cancellation as identified by the key tag number.

Prior to cancellation, the key tag owner must confirm the cancellation request as in Step 158. If the key tag owner wishes to abort or cancel the cancellation request, the key tag owner may do so by affirmatively canceling the request as in Step 160. In that event, the system of the invention will abort the cancellation for the targeted key tags and return the key tag owner to Step 83. In the alternative, if the key tag owner wishes to proceed with the cancellation, by submitting the cancellation request as in Step 161 (not shown) the key tag owner receives confirmation of the cancellation (Step 162) and instructions for the key tag's return. Upon cancellation of a key tag's membership, a key tag owner will be required to return the cancelled key tag(s), such that the key tag owner does not unjustly enjoy the benefits of the lost key rewards system and method without paying the appropriate fees. If the key tag owner fails to return the key tag(s) within the specified time, they risk forfeiture of credit and/or additional charges for the unreturned key tag(s).

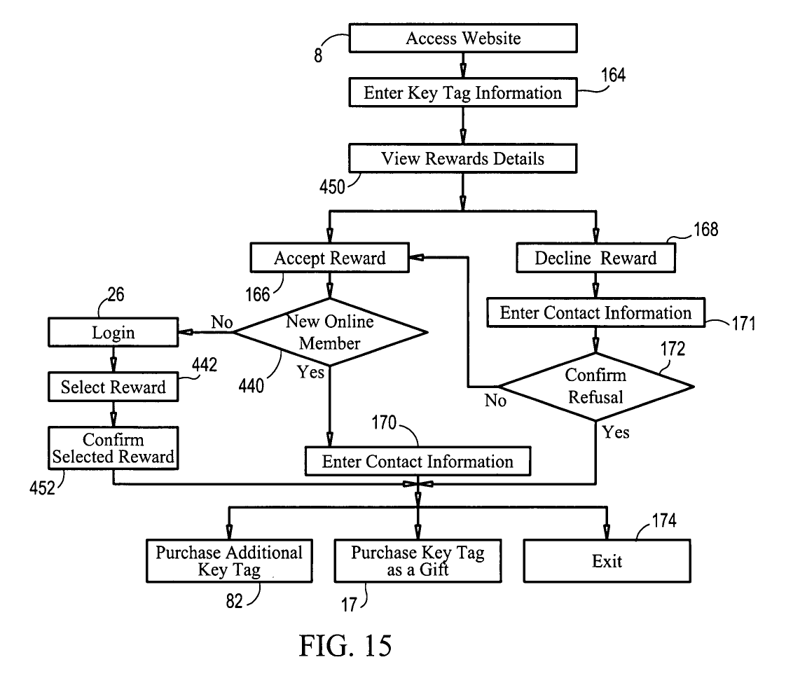

FIG. 15 is a schematic illustration of how an anonymous key tag finder may report found keys using the invention. When an anonymous key tag finder finds lost keys and/or key tags, they may (i) mail and/or hand deliver the found keys and/or key tag pursuant to the printed instructions on the key tag; (ii) report the found keys (Step 163, not shown) to the lost key rewards system and method by telephone, email, facsimile and/or may send an SMS text message via their cell phone; or (iii) access the website using the Internet as seen in Step 8.

Should the key tag finder elect to report the found keys (Step 163, not shown) by accessing the website (Step 8) or any other methods previously mentioned, the system of the invention automatically generates an e-mail and/or SMS text message notifying the owner of the status of the found keys. The key tag owner may also be notified by mail, hand delivery, facsimile message, or a telephone call of the found keys. For example the SMS text may state: “Your keys have been found;” “We are in the process of trying to retrieve your keys;” “Your keys are in our possession;” or any other like messages or notification of similar content or import. The key tag finder's cell phone number may also be retained to send a return SMS text message instructing the key tag finder as to how to login to the system of the invention with a cell phone number and/or the lost key tag number to receive the reward. In an alternate embodiment of the invention, the key tag finder may be additionally assigned a temporary password which would be required to login and receive the reward.

In either event, the key tag finder must identify the found key tag by entering the unique key tag number (Step 164) located on the key tag. The invention will receive the unique identifier and will confirm that the key tag number entered is valid as well as the identity and contact information for that key tag owner. As soon as the central electronic database 247 of the invention is updated reflecting that the keys and/or key tag have been found, the system of the invention will automatically update the status of that specific key tag in realtime to reflect, for example that the keys are in the process of being retrieved, or some other like notification. The system of the invention may also provide realtime update notification by SMS text and/or e-mail to the key tag owner that the keys have been found as soon as the database 247 of the invention is updated reflecting the same. If the key tag number is valid, the key tag finder may view the rewards details (Step 450) and choose to participate in the rewards program by either accepting (Step 166), or declining the reward (Step 168).

Should the key tag finder choose to participate in the lost key reward program by accepting the reward (Step 166), they need to indicate if they are a new online member (Step 440) of the lost key rewards system in which case they will need to enter their contact information (Step 170) as in name, address, email address, etc., to direct the reward to an appropriate mailing address. Such rewards may include but is not limited to a free key tag and/or free membership for one year. The key tag finder may then proceed to either purchase an additional key tag(s) as in Step 82, purchase key tags as a gift (Step 17) or exit the lost key reward system (Step 174).

If the key tag finder is already an existing member of the lost key rewards system, the key tag finder will need to login (Step 26) to the system with their unique identifier and password, and select the reward (Step 442) that they would prefer, e.g. free key tag or renewal of an expired or inactive key tag's membership with waiver of any renewal and/or activation fees for the expired or inactive key tag, or any other promotional rewards that are currently being offered. The key tag finder will have an additional opportunity to confirm the selected reward (Step 452), as well as purchase an additional key tag(s) as in Step 82, purchase key tags as gift (Step 17) or exit the lost key reward system (Step 174).

If the key tag finder elects to decline the reward (Step 168), it would still be helpful to have their contact information for future reference in the event there are problems with retrieving the found key tag and keys. Thus, the system of the invention will prompt the key tag finder to enter some limited contact information as in Step 171, which in the preferred embodiment, includes the key tag finder's email and/or telephone numbers, and confirm their refusal of the reward as in Step 172. If the key tag finder further declines to participate in the lost key reward system and method, the key tag finder still has an opportunity to either purchase an additional key tag(s) as in Step 82, purchase key tags as gift (Step 17) or exit the lost key reward system (Step 174).

If after confirming their refusal of the reward (Step 172), the key tag finder changes their mind and decides to accept the reward (Step 166), the key tag finder will be directed to proceed through Steps 166-Step 170 or Step 452, depending on whether they are a new or existing member of the lost key rewards system and method. Thereafter the key tag finder may proceed to either purchase additional key tags (Step 82), purchase key tags as gifts (Step 17) or exit the lost key reward system and method as in (Step 174). Notably, prior to exiting the lost key rewards system and method the key tag finder will be provided with instructions for forwarding the found keys.

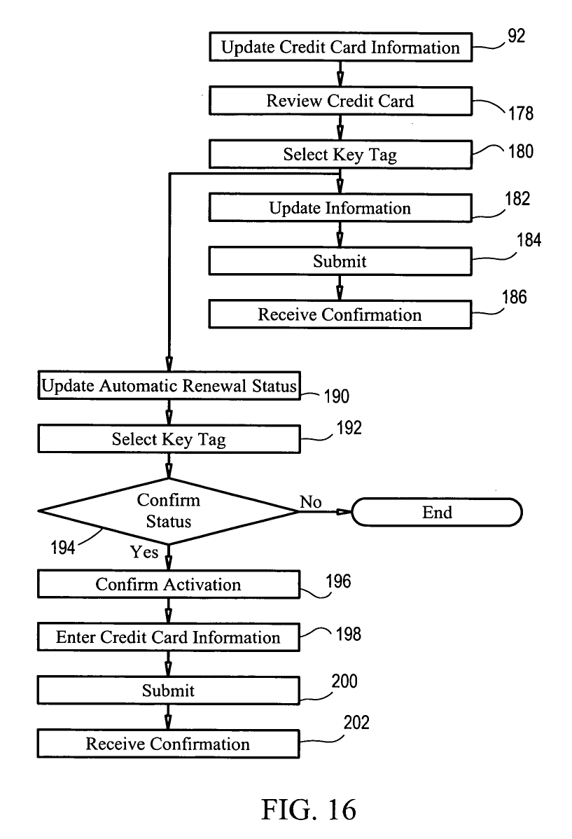

FIG. 16 is a schematic illustration of how a key tag owner may update their credit card information and membership information using the invention. A key tag owner may elect to update their credit card information as in Step 92 and the system of the invention will automatically display their credit card information for each key tag owned. The key tag owner may then review each key tag's credit card information as in Step 178. Similar to the renewal or reactivation of key tags, although a key tag owner may own multiple key tags, the key tag owner may limit the credit card updates to one or more key tags. To do so, the key tag owner must select the specific key tag(s) as in Step 180 that they wish to update and proceed to update the respective credit card information as in Step 182, e.g. type of credit card, credit card number, etc. It is understood that that the system of the invention will provide encryption of the credit card numbers for security purposes as is well known and used in the arts. If the entered information is satisfactory, the key tag owner may submit the update request as in Step 184 and proceed to receive confirmation (Step 186) of the updated credit card information.

A key tag owner also has the option of automatically renewing their membership (Step 190) with the lost key rewards system and method where any applicable renewal fee is automatically billed to a specified credit card. The key tag owner may enable or disable the automatic renewal by electing to update their automatic renewal status (Step 190) of their yearly membership fee. In that event, the system of the invention will display their renewal status information for each key tag owned. The renewal status information displayed may include but is not limited to, each key tag owned, the credit card number and type, expiration date and the status of the automatic renewal. The key tag owner may then select the key tag(s) (Step 192) being enabled or disabled for automatic renewal and confirm whether or not they would like the automatic renewal status updated as in Step 194. If they choose to disable the automatic renewal function, then there will be no additional charges and no additional input is required. However, the selected key tag where the automatic renewal was disabled will not be automatically renewed once expired.

If the key tag owner chooses to activate the automatic renewal function as in Step 194 then they must confirm the activation as in Step 196, enter their credit card information as in Step 198, submit (Step 200) the credit card information for charges and proceed to receive confirmation of the charges as in Step 202.

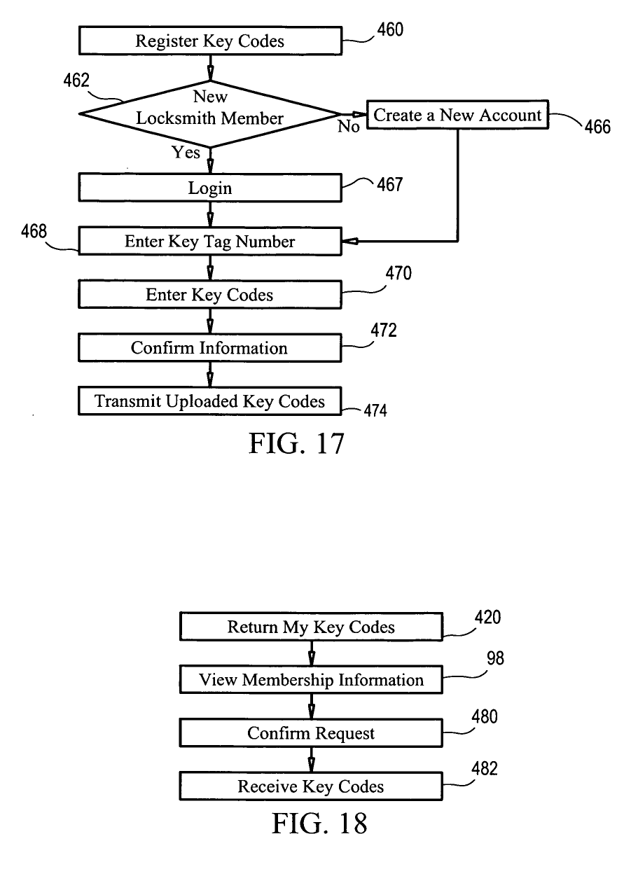

FIG. 17 is a schematic illustration of a method of registering key codes using the invention. “Advanced”, programmable and traditional key owners may register their decoded key code(s) with the lost key rewards system and method prior to needing a replacement or duplicate key. There are various options available for decoding the “advanced”, programmable and traditional keys, i.e. a locksmith may either sight decode the traditional key, use a key decoding machine to decipher the “advanced”, programmable and traditional key codes or take the “advanced” or programmable key apart to decipher the key codes. In either event, the decoded key information can be transmitted, registered and stored with the lost key rewards system and method for retrieval on an as needed basis.

The invention provides for a co-operative and/or participating locksmith to be able to register the key codes (Step 460) with the system of the invention using a locksmith portal. If the locksmith seeking to register the key codes (Step 460) is a new locksmith member (Step 462) of the lost key rewards system and method, the locksmith will be prompted to create a new account (Step 466) providing their contact information, name, address, telephone numbers, etc. and they will be assigned a unique identifier and/or password for future logins. If the locksmith is already a participating member of the lost key and rewards system, the locksmith will be prompted to login (Step 467) with their unique identifier and password that will be validated by a password verification system that is well known and used in the arts. In either event, the key tag number for the decoded key that is being registered must be entered and identified (Step 468) and the locksmith may then proceed to enter the key codes (Step 470), e.g. codes, year, model, type of keys, etc. to the system of the invention. The locksmith may be provided with an opportunity to confirm the decoded information (Step 472) prior to transmitting the uploaded key codes (Step 474) to the lost key rewards system and method using the locksmith portal via varied transmitting means. The system of the invention is enabled to receive the decoded key information from the locksmith or the key owner, via varied receiving means which are similar if not identical to the transmitting means used for receiving the decoded key information and which include but is not limited to mail, hand delivery, facsimile, e-mail, photocopying, scanning, manual entry, other electronic means which allows automatic data transfer directly from the locksmith's key decoding machine to system of the invention, or any other receiving or transmitting means that are well known and used in the arts.

Upon receipt of the decoded key information, the lost key rewards system and method uses the key tag owner's unique identifier to identify the appropriate “advanced”, programmable and traditional key owner for whom the decoded information is being received. After the appropriate key tag owner is identified, the lost key rewards system and method stores the decoded key information for the appropriate key in a secure central electronic database 247 where its contents are protected and kept on a confidential basis. Thus, when a key owner has lost, misplaced or needs a duplicate key, the key owner may access the lost key rewards system and method (Step 8 not shown) to request the return of stored decoded key information (Step 420, not shown) for the appropriate key anywhere in the world.

FIG. 18 is a schematic illustration of a method of gaining access to a secured item which uses, for example a locked boat, car, motorcycle or home, etc., using the invention. In the first instance, the key tag owner must have first decoded the key codes (Step 524, not shown) for a specific key that is associated with a key tag that is unique to the key tag owner and have the key codes registered (Step 460-474, not shown) with the lost key rewards system, such that the key tag owner can access the lost key rewards system to request the return of the decoded and stored key codes (Step 420).

Once the system of the invention receives the request for the return of key codes (Step 420), the system of the invention will display the key tag membership status for the related key tag and the key tag owner may then view the membership status information (Step 98) for further details, e.g. loss event, date lost, etc. The key tag owner must confirm the request (Step 480) for the key codes prior to receiving the same. In certain embodiments of the invention, the confirmation process (Step 480) is a multi-step process which may also include providing a password (Step 525, not shown) that will be validated by a password verification system and an additional confirmation step (Step 526, not shown). Once the specific key for which its key codes are being requested is confirmed (Step 480), the key tag owner can receive the key codes via various receiving means. The system of the invention uses several different transmitting means to send the key codes to the key tag owner that are similar if not identical to the receiving means. Such transmitting and receiving means may include but is not limited to transmitting and receiving the information to or from the key owner or a certified co-operative or non-cooperative locksmith via mail, hand delivery, facsimile, e-mail, locksmith portal or other transmitting means that would transmit the decoded key information directly from the lost key rewards system and method to the certified locksmith's key decoding machine. The transmitting and/or receiving means may also include any other transmitting means that are well known and used in the arts anywhere in the world. Thus, the “advanced”, programmable, traditional key owner and/or the locksmith can receive the decoded key information and now have the necessary information to duplicate the key(s). In this manner, the “advanced”, programmable and traditional key owner is able to gain access to the secured item in a timely, cost efficient manner anywhere in the world.

Other modifications and implementations will occur to those skilled in the art without departing from the spirit and the scope of the invention as claimed. Accordingly, the invention is to be defined not by the preceding illustrative description but instead by the following claims.

What is claimed is:

1. A method of providing for the return of lost keys comprising the steps of:
a. registering at least one key tag with a central electronic database, where each key tag has a unique key tag number which serves as a unique identifier for an anonymous key tag owner;
b. storing contact information for the anonymous key tag owner such that the identity of the key tag owner is readily identifiable by the system but remains anonymous to an anonymous key tag finder;
c. retrieving lost key tag and keys from an anonymous key tag finder for the return to the anonymous key tag owner by providing instructions to the anonymous key tag finder for the return of the lost keys and key tag; and
d. returning the lost keys that have been found to the anonymous key tag owner.

2. The method of claim 1, wherein the step of retrieving lost and stolen keys comprises the steps of:
a. receiving notification of found keys and key tag that was previously lost; and
b. updating the status of lost keys to reflect that the lost key tag and keys have been found.

3. The method of claim 2, wherein the step of retrieving lost and stolen keys comprises the steps of: receiving a report from the key tag owner of a loss event for a specific key tag that was lost.

4. The method of claim 2, wherein the step of retrieving lost and stolen keys comprises the steps of: receiving notification from the anonymous key tag finder of the found key tag and keys.

5. The method of claim 2, wherein the step of retrieving lost and stolen keys comprises the step of providing notification of found keys and key tag to the anonymous key tag owner.

6. The method of claim 5, wherein the step of providing notification further comprises providing notification by any one or more of the following means: e-mail; text messages; telephone; hand delivery, manually, facsimile message; or regular mail.

7. The method of claim 1, further comprising the step of providing for participation in a lost key rewards program.

8. The method of claim 7, further comprising the step of accepting a reward for returning found keys wherein said reward may comprise of any one of the following: free key tag membership, free key tag, waiver of renewal or reactivation fees or other prize giveaways.

9. The method of claim 1, wherein the step of retrieving lost and stolen keys comprises the steps of:
a. activating a locator tracking device embedded within the key tag to determine a geographical position of the lost key tag and keys;
b. tracking the location of the lost key tag and keys; and
c. locating and retrieving the lost key tag and keys for the return to the key tag owner.

10. The method of claim 1, wherein the step of returning the lost keys that have been found comprises the steps of:
a. receiving notification from the anonymous key tag finder of found key tag and keys that are owned by an anonymous key tag owner;
b. sending notification to the anonymous key tag owner that the lost key tag and keys have been found; and
c. receiving the lost key tag and keys from the anonymous key tag finder.

11. The method of claim 10, further comprising the steps of sending notification by any one or more of the following means: e-mail; text messages; hand delivery; telephone call; facsimile message; or regular mail.

12. The method of claim 1, wherein the step of returning the lost keys that have been found comprises the step of receiving a request from the key tag owner for the return of their found keys and/or key tag.

13. A method of gaining access to a secured item, comprising the steps of:
a. registering at least one key tag with a central electronic database, where each key tag has a unique key tag number which serves as a unique identifier for an anonymous key tag owner;
b. storing contact information for the anonymous key tag owner such that the identity of the key tag owner is readily identifiable by the system but remains anonymous to an anonymous key tag finder;
c. receiving and registering decoded key codes and key information for a specific key associated with the unique key tag number and key tag owner via receiving means;
d. receiving a request for the stored decoded key codes for the specific key associated with the anonymous key tag owner; and
e. transmitting the stored decoded key codes to a locksmith for the duplication of that specific key via transmitting means.

14. The transmitting means of claim 13, further comprising any one or more of the following means: mail, scanned entry, e-mail, text messages, telephone, facsimile, hand delivery, manual entry, telephone, photocopying, or electronic transfer to a key decoding machine via a locksmith portal.

15. The receiving means of claim 13, further comprising any one or more of the following means: photocopying, mail, scanned entry, e-mail, text messages, telephone, facsimile, hand delivery, manually, telephone, or electronic transfer to a key decoding machine via a locksmith portal.

16. The keys of claim 13 further comprising any one or more of the following: advanced, programmable or traditional keys.

17. A system of providing for the return of lost keys comprising:
a. a memory device; and
b. a processor disposed in communication with the memory device, the processor configured to:
i. register at least one key tag with the central electronic database, where each key tag has a unique key tag number which serves as a unique identifier for an anonymous key tag owner;
ii. store contact information for the anonymous key tag owner such that the identity of the key tag owner is readily identifiable by the system, but remains anonymous to an anonymous key tag finder;
iii. retrieve lost key tag and keys from an anonymous key tag finder for the return to the anonymous key tag owner by providing instructions to the anonymous key tag finder for the return of the lost keys and key tag; and
iv. return the lost keys that have been found to the anonymous key tag owner.

18. The system of claim 17, further comprising:
a. a memory device; and
b. a processor disposed in communication with the memory device, the processor configured to:
i. receive notification of found keys and key tag that was previously lost; and
ii. update the status of lost keys to reflect that the lost key tag and keys have been found.

19. A system of claim 18, further comprising:
a. a memory device; and
b. a processor disposed in communication with the memory device, the processor configured to:
i. receive a report from the key tag owner of a loss event for a specific key tag that was lost.

20. A system of claim 18, further comprising:
a. a memory device; and
b. a processor disposed in communication with the memory device, the processor configured to:
i. receive notification from the anonymous key tag finder of the found key tag and keys.

21. A system of claim 18 further comprising:
a. a memory device; and
b. a processor disposed in communication with the memory device, the processor configured to:
i. provide notification of found keys and key tag to the anonymous key tag owner.

22. A system of claim 18 further comprising:
a. a memory device; and
b. a processor disposed in communication with the memory device, the processor configured to:
i. provide notification by any one or more of the following means: e-mail; text messages; telephone call; hand delivery; facsimile message; or regular mail.

23. A system of claim 17, further comprising:
a. a memory device; and
b. a processor disposed in communication with the memory device, the processor configured to:
i. provide for participation in a lost key rewards program.

24. A system of claim 17, further comprising:
a. a memory device; and
b. a processor disposed in communication with the memory device, the processor configured to:
i. activate a locator tracking device embedded within the key tag to determine a geographical position of the lost key tag and keys;
ii. track the location of the lost key tag and keys; and
iii. locate and retrieve the lost key tag and keys for the return to the anonymous key tag owner.

25. A system of claim 17, further comprising:
a. a memory device; and
b. a processor disposed in communication with the memory device, the processor configured to:
i. receive notification from an anonymous key tag finder of found key tag and keys that are owned by an anonymous key tag owner;
ii. send notification to the anonymous key tag owner that the lost key tag and keys have been found; and
iii. receive the lost key tag and keys from the anonymous key tag finder.

26. The system of claim 25, further comprising:
a. a memory device; and
b. a processor disposed in communication with the memory device, the processor configured to:
i. send notification by any one or more of the following means: e-mail; text messages; hand delivery, telephone call; facsimile message; or regular mail.

27. A system of claim 17, further comprising:
a. a memory device; and
b. a processor disposed in communication with the memory device, the processor configured to:
i. receive a request from the key tag owner for the return of their found keys and/or key tag.

28. A system of gaining access to a secured item, comprising:
a. a memory device; and
b. a processor disposed in communication with the memory device, the processor configured to:
i. register at least one key tag with a central electronic database, where each key tag has a unique key tag number which serves as a unique identifier for an anonymous key tag owner;
ii. store contact information for the anonymous key tag owner such that the identity of the key tag owner is readily identifiable by the system but remains anonymous to an anonymous key tag finder;
iii. receive and register decoded key codes and key information for a specific key associated with the unique key tag number and key tag owner via receiving means;
iv. receive a request for the stored decoded key codes for the specific key associated with the anonymous key tag owner; and
v. transmit the stored decoded key codes to a locksmith for the duplication of that specific key via transmitting means.

29. A computer readable medium comprising:
a. instruction code for accessing and updating a database;
b. instruction code for registering and storing decoded key information;
c. instruction code for identifying an anonymous key tag owner for whom decoded key codes were received; and
d. instruction code for processing requests for the decoded key information for the keys.
